(19) United States
(12) Patent Application Publication
(10) Pub. No.: US 2007/0280754 A1
(43) Pub. Date: Dec. 6, 2007

(54) Fixing device and image forming apparatus

(75) Inventors: Tadashi Ogawa, Tokyo (JP); Toshiaki Higaya, Kanagawa (JP); Hiroshi Seo, Kanagawa (JP); Akiko Ito, Tokyo (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 11/806,748

(22) Filed: Jun. 4, 2007

(30) Foreign Application Priority Data
Jun. 5, 2006 (JP) 2006-155891

(51) Int. Cl. G03G 15/20

(52) U.S. Cl. 399/328; 399/333

(57) ABSTRACT

A fixing device includes a fixing sleeve, a cylindrical fixing roller, and a pressure roller. The fixing sleeve includes a heating layer that generates heat to fuse and fix toner. The fixing roller has a surface covered with the fixing sleeve. The pressure roller presses the fixing roller via the fixing sleeve to form a nip portion. The fixing sleeve is freely rotatable with respect to the fixing roller, and is slid for rotation.

### CROSS-REFERENCE TO RELATED APPLICATIONS

The present document incorporates by reference the entire contents of Japanese priority document, 2006-155891 filed in Japan on Jun. 5, 2006.

### BACKGROUND OF THE INVENTION

1. Field of the Invention

The present invention relates to an image forming apparatus, and a fixing device.

2. Description of the Related Art

In recent years, image forming apparatuses, such as printers, copiers, and facsimile machines have been increasingly required to consume less power and required to operate at a high speed. To meet the requirement, there is a need for improving thermal efficiency of a fixing device in an image forming apparatus.

Such an image forming apparatus forms an unfixed toner image, through an image forming process such as electrophotographic recording, electrostatic recording, or magnetic recording, on a recording material such as recording sheet, printing paper, photosensitive paper, or electrostatic recording sheet by a transfer (indirect) system or a direct system. The image forming apparatus employs a fixing device that fixes the unfixed toner image by contact-heat fixing, such as heat-roller fixing, film-heat fixing, or electromagnetic induction heat-fixing, have been widely adopted.

A heat-roller fixing device basically includes paired rotating rollers. The paired rotating rollers are formed of a fixing roller having therein a heat source such as a halogen lamp that is controlled at a predetermined temperature and a pressure roller pressed onto the fixing roller. A recording material is introduced to a contact portion, i.e., a fixing nip, between the paired rotating rollers for conveyance. With heat and pressure from the fixing roller and the pressure roller, an unfixed toner image is fused to be fixed.

Examples of film-heat fixing devices have been proposed in Japanese Patent Application Laid-Open Nos. S63-313182 and H1-253579.

In the conventional fixing device, a recording material is closely made contact with a heating member fixedly supported by a supporting member via a thin, heat-resisting fixing film. With the fixing film being slid for movement with respect to the heating member, heat from the heating member is supplied to the recording material via the film material. For this fixing device, a ceramic heater is used having a resistant layer on a ceramic substrate made of alumina, aluminum nitride, or the like, with characteristics, such as heat resistance, insulation, and excellent thermal conductivity. For this fixing device, a thin film with a small heat capacity can be used as a fixing film, and therefore, heat transfer efficiency of this fixing device is higher than that of the heat-roller fixing device. Thus, a warm-up time can be reduced, thereby achieving a quick start and energy saving.

As an electromagnetic induction heat-fixing device, Japanese Utility-Model Application Laid-Open Publication No. 51-109739 has proposed an induction-heating fixing device that induces an eddy current in a metal layer (heating layer) of a fixing sleeve through magnetic fluxes for heating with its Joule heat.

In the electromagnetic induction heat-fixing, the occurrence of the induced current is used to directly heat the fixing film. With this, a fixing process with higher efficiency can be achieved compared to that of the heat-roller fixing device with a halogen lamp as a heat source.

Such a conventional electromagnetic induction heat-fixing device generally includes a fixing sleeve and a fixing roller. The fixing sleeve has a releasing layer, an elastic layer, and a heating layer. The fixing roller is formed of an elastic layer that holds the fixing sleeve in a roller shape and a supporting member (core metal). The fixing roller and a pressure roller mutually press each other via the fixing sleeve, and form a press nip therebetween.

In this configuration, the fixing sleeve is bonded to the fixing roller with primer or the like, thereby being prevented from moving (shifting) in an axial direction.

However, if the fixing sleeve and the fixing roller are bonded together, when the hardness of the elastic layer of the fixing roller is decreased with time or a rupture occurs at the fixing sleeve, the whole fixing sleeve and the fixing roller have to be replaced. This poses problems in maintainability and cost compared to a configuration that allows individual replacement.

### SUMMARY OF THE INVENTION

It is an object of the present invention to at least partially solve the problems in the conventional technology.

According to an aspect of the present invention, a fixing device includes a fixing sleeve that includes a heating layer that generates heat to fuse and fix toner, a fixing roller that is cylindrical and has a surface covered with the fixing sleeve, and a pressure roller that presses the fixing roller via the fixing sleeve to form a nip portion. The fixing sleeve is rotatable with respect to the fixing roller, and is slid for rotation.

According to another aspect of the present invention, an image forming apparatus includes a fixing device that includes a fixing sleeve having a heating layer that generates heat to fuse and fix toner, a cylindrical fixing roller that has a surface covered with the fixing sleeve, and a pressure roller that presses the fixing roller via the fixing sleeve to form a nip portion. The fixing sleeve is rotatable with respect to the fixing roller, and is slid for rotation.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a cross section of a fixing device according to an embodiment of the present invention;

FIG. 2 is a cross section of a fixing device according to Example 1;

FIG. 3 is a cross section of a fixing device according to Example 2;

FIG. 4 is a cross section of a fixing device according to Example 3; and

FIG. 5 is a cross section of an image forming apparatus according to the embodiment.

### DETAILED DESCRIPTION OF THE PREFERRED EMBODIMENTS

Exemplary embodiments of the present invention are explained in detail below with reference to the accompanying drawings. Incidentally, like reference characters refer to corresponding portions throughout the drawings.

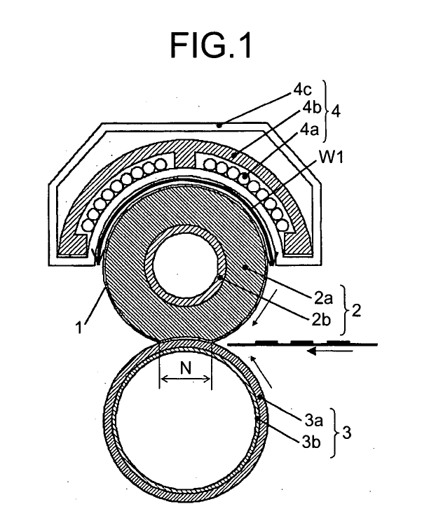

FIG. 1 is a cross section of a fixing device according to an embodiment of the present invention. The fixing device includes a fixing sleeve 1 heated through electromagnetic induction by an induction heating unit, a fixing roller 2 having its surface covered with the fixing sleeve 1, and a pressure roller 3 that is pressed against the fixing roller 2 via the fixing sleeve 1 and rotates in a forward direction with respect to the fixing sleeve 1. The fixing sleeve 1 can be freely moved with respect to the fixing roller 2, and rotates in contact with the sliding pressure roller 3.

In the embodiment, the fixing sleeve 1 is hollow, covering the surface of the fixing roller 2 and having accommodated therein the fixing roller 2. Preferably, the fixing sleeve 1 is a thin, cylindrical, hollow rotating member that can freely rotate with respect to the fixing roller 2.

The fixing sleeve 1 is made by plating a base material with a conductor serving as a heating layer having a thickness of 5 micrometers to 20 micrometers. The base material is made of a magnetic metal such as iron, cobalt, nickel, and an alloy of these metals, a non-magnetic metal such as SUS304 and SUS316, or polyimide resin. Examples of the conductor include copper, silver, and aluminum. The thickness of the base material is 30 micrometers to 100 micrometers, and its outer diameter is 40 millimeters in the embodiment.

The fixing sleeve 1 includes, in particular, if it is the one for use in a color fixing device, to prevent uneven fixing, an elastic layer made of silicone rubber of, for example, 30 micrometers to 200 micrometers. The elastic layer is coated with a pulverized fuel ash (PFA) tube of, for example, 20 micrometers to 200 micrometers, as a toner releasing layer.

The fixing roller 2 preferably includes a cylindrical shaft portion-and a body portion provided on the outer circumference surface of the shaft portion. Preferably, a metal is used for the shaft portion of the fixing roller 2, whilst a nonmetal is used for the body portion. The fixing roller 2 includes a cylindrical core metal 2b made of stainless steel or the like serving as a shaft portion and a body portion 2a formed by coating the outer circumference of the core metal 2b with heat-resistant elastic or foamed silicone rubber having a constant thickness. The thickness of the body portion 2a is, for example, 2 millimeters to 9 millimeters, and the hardness on the shaft is on the order of Asker C hardness of 20 to 50.

The pressure roller 3 includes a core metal 3b and an elastic member 3a. The core metal 3b is formed of a cylindrical metal with high heat conductivity, such as copper or aluminum. The elastic member 3a with high heat-resistance is provided on the surface of the core metal 3b. The elastic member 3a has a multilayered structure of a silicone rubber layer having a thickness of, for example, 1 millimeter to 5 millimeters covered with a PFA tube excellent in toner releasing characteristic having a thickness of, for example, 20 micrometers to 50 micrometers. In the embodiment, the outer circumference is 40 millimeters.

An electromagnetic induction heating device 4 is an induction heating unit that induces heat of the heating layer of the fixing sleeve 1 through electromagnetic induction to heat the fixing sleeve 1. The electromagnetic induction heating device 4 includes excitation coils 4a serving as magnetic-field generating units and a coil housing 4c having therein the excitation coils 4a on the fixing sleeve 1 side. The coil housing 4c is adjacently disposed on the outer circumference of the fixing sleeve 1. The excitation coils 4a are disposed so that one excitation coil material is parallel to an axial direction of the fixing sleeve 1 along the surface of the coil housing 4c. In the embodiment, the excitation coils 4a are disposed so that the directions of magnetic fields formed by the adjacent excitation coils 4a in a circumference direction of the fixing sleeve are opposite to each other. With this, magnetic fluxes formed by the adjacent coils can be prevented from being cancelled each other.

The excitation coils 4a are connected to a drive power supply (not shown) with a frequency-variable oscillating circuit. To form a more powerful magnetic field, a core material formed of a ferromagnet can be provided at the center of the excitation coils 4a. Outside of the excitation coils 4a, an excitation coil core 4b formed of a ferromagnet, such as ferrite, is fixed to the coil housing, and is adjacently disposed so as to cover the excitation coils 4a from the side opposite to the fixing sleeve 1. With this, the generated magnetic fluxes caused to be concentrated onto the fixing sleeve 1 side to allow highly-efficient heating. At the same time, the magnetic fluxes can be prevented from being leaked to the outside of the fixing device to inadvertently heat peripheral members. In the embodiment, as the excitation coil core 4b, the one with a relative magnetic permeability of 2500 is used.

The excitation coils 4a are supplied from the drive power supply with a high-frequency alternating current of 10 kilohertz to 1 megahertz, preferably 20 kilohertz to 40 kilohertz, thereby causing an alternating magnetic field. This alternating magnetic field acts on the heating layer of the fixing sleeve in a fixing sleeve area W1 near the excitation coils and its near portions. Inside the heating layer, an eddy current flows in a direction interfering with a change in alternating magnetic field.

This eddy current causes Joule heat according to a resistance of the heating layer of the fixing sleeve, thereby causing an electromagnetic induction heating on the fixing sleeve in the fixing sleeve area W1 near the excitation coils and its near portions.

When the fixing device configured as above is used, the pressure roller 3 is first rotated by the drive power supply, thereby causing the fixing sleeve 1 to be slid for rotation. At this time, with an eddy current occurring due to fluctuations in magnetic fluxes generated from the electromagnetic induction heating device 4 driven at the same time, the surface of the rotating fixing sleeve 1 is heated to a predetermined temperature evenly in a circumferential direction and an axial direction. At the nip portion, toner on a recording medium is fused and fixed through heat and pressure to form an image. The fixing roller 2 can be rotated by a rotating force from the slid and rotating fixing sleeve 1 or can be fixed to the fixing device not to be rotated without being influenced from the rotation of the fixing sleeve 1.

At the time of disassembling the fixing device configured as above, a pressure lever 7 provided to the fixing device is released to remove the non-disassembled fixing sleeve 1 and the fixing roller 2 from the inside of the device, and then the fixing sleeve 1 and the fixing roller 2 are disassembled for replacing a deteriorated or damaged component or the like.

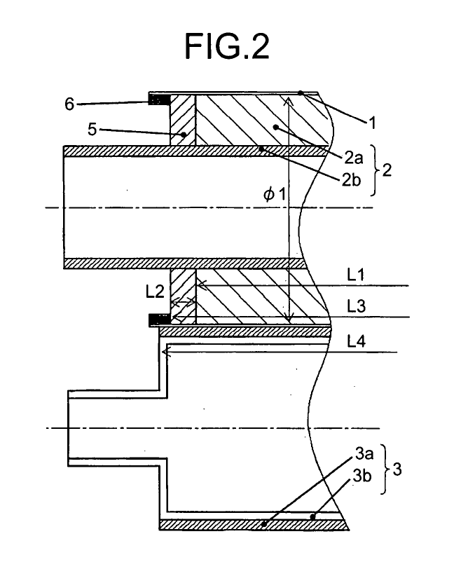

In the following, examples of the fixing sleeve 1, the fixing roller 2, and the pressure roller 3 that constitute the fixing device according to the embodiment are explained with reference to FIGS. 2 to 4.

### EXAMPLE 1

FIG. 2 is a cross section of the fixing sleeve 1, the fixing roller 2, and an area near the end of the pressure roller 3 according to Example 1.

In the fixing device having the configuration mentioned above, the fixing roller 2 has an outer diameter φ1 of 40 millimeters and a body-portion length L1 of 320 millimeters, for example. The body portion includes at its end a high-stiffness ring 5 formed of silicone rubber with Asker C hardness of, for example, 60, which is higher than that of the elastic layer of the fixing roller 2 with Asker C hardness of, for example, 20 to 50. The ring has an outer diameter of 40 millimeters and a width L2 of 5 millimeters. On the inner circumference of the end of the fixing sleeve 1, a guide 6 made of heat-resistant silicone rubber is adhered to the entire area in the circumferential direction. The guide 6 serves as a shift stop and protrudes from the inner circumference surface to the inner diameter center direction. With the guide 6 abutting the ring 5 in an axial direction of the fixing sleeve 1, the fixing sleeve 1 can be prevented from being shifted to the axial direction thereof. Also, since the ring 5 is an elastic member, the ring 5 is deformed by the pressure of the pressure roller 3 at the nip portion. Therefore, a shift can be stopped along the nip shape.

The length L4 in an axial direction of the body portion of the pressure roller 3 is 335 millimeters. Because this length is longer than a length L3 in an axial direction of the body portion of the fixing roller 2 and the ring 5: 330 millimeters, the nip portion can be prevented from running upon the guide 6 due to deformation of the end of the fixing sleeve 1.

A heat-resistant grease, such as a fluorine grease, is applied as required to the inner surface of the fixing sleeve 1, which reduces a shifting force in an axial direction of the fixing sleeve 1 and prevents the shift-stopping guide 6 from running upon the shift-stopping ring 5.

The fixing sleeve 1 and the fixing roller 2 can be easily mounted by mounting the ring 5 on the fixing roller 2, coating the outer circumference of the fixing roller 2 with the fixing sleeve 1, and then bonding the guide 6 to a predetermined position of the fixing sleeve 1.

As explained above, with the fixing device according to the embodiment, the fixing sleeve can be prevented from being shifted in the axial direction. Also, the fixing sleeve can be prevented from running upon the guide, and the guide can be prevented from running upon the ring.

With these effects, even when the fixing sleeve and the fixing roller 2 can be freely rotated, the fixing sleeve is not shifted and no component runs upon another component. Thus, the fixing device is excellent in maintainability and cost, and ensures stable fixing performance.

### EXAMPLE 2

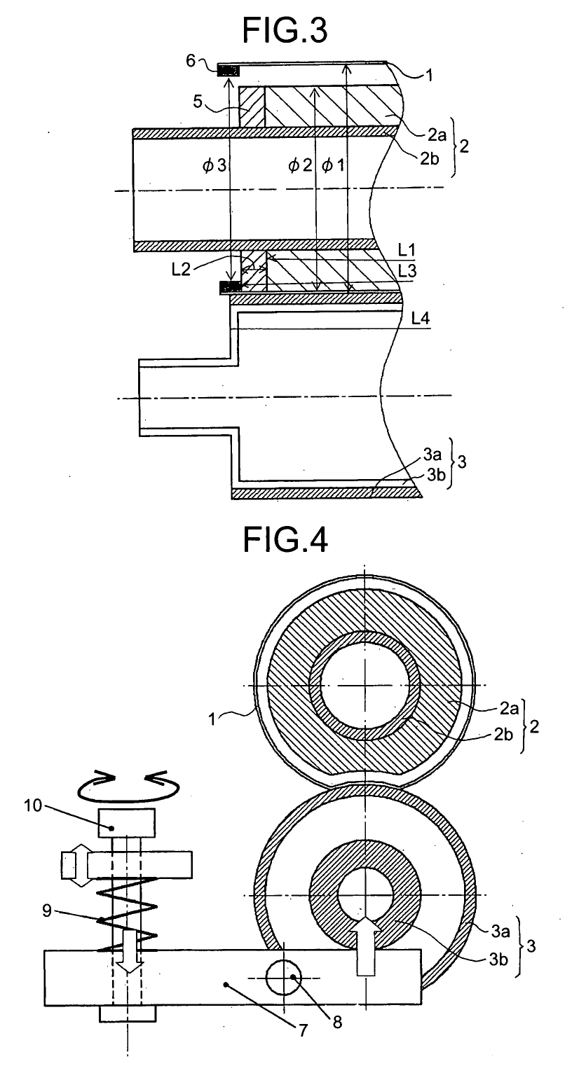

FIG. 3 is a cross section of the fixing sleeve.1, the fixing roller 2, and the pressure roller 3 that constitute the fixing device according to Example 2.

In the fixing device of Example 2, an outer diameter φ2 of the fixing roller 2 and the ring 5 is 35 millimeters, and an inner diameter φ3 of the guide 6 is 36 millimeters. In this configuration, in use, the fixing sleeve 1 and the fixing roller 2 make contact with each other by being pressed by the pressure roller 3, and form a nip portion with the pressure roller 3. Therefore, the guide 6 provided at the end of the fixing sleeve 1 and the ring 5 provided at the end of the fixing roller 2 abut at least on the nip portion, thereby achieving a shift-stopping effect. On the other hand, when disassembled, the fixing sleeve 1 and the fixing roller 2 is released from the pressure of the pressure roller 3, thereby not forming a nip portion. With this, the fixing sleeve 1 can be in a non-contact state without being pressed by the fixing roller 2. That is, without removing the guide 6, the ring 5 and the fixing roller 2 each having an inner diameter smaller than that of the guide 6 can be extracted from the fixing sleeve 1. Therefore, the configuration is excellent in maintainability and cost.

### EXAMPLE 3

FIG. 4 is a cross section of the fixing sleeve 1, the fixing roller 2, and the pressure roller 3 that constitute the fixing device according to Example 3.

In the fixing device having the configuration mentioned above, the ring 5 and the guide 6 are provided only on one side of the ends. As shown in FIG. 4, the pressure lever 7 supported at its both bottoms by a fulcrum 8 is pressed by a spring 9, thereby forming a pressure nip between the fixing roller 2 and the pressure roller 3. The pressure of the compression spring can be adjusted by a pressure adjusting screw 10, and the parallelism between the fixing roller 2 and the pressure roller 3 can also be adjusted. The parallelism can be adjusted by, since the fixing roller 2 is fixed, pressing up the core metal 3b of the pressure roller 3 and the pressure lever 7 in an upward direction in FIG. 4. When the parallelism is adjusted, the shifting direction of the fixing sleeve 1 is adjusted to a side where the ring and the guide touch each other. With this, a shift of the fixing sleeve 1 can be prevented.

In Example 3, neither the ring 5 nor the guide 6 is required at an end on the side opposite to the shift, which reduces cost. In addition, the fixing roller 2 and the fixing sleeve 1 can be easily disassembled from the side without a guide, resulting in a configuration excellent in maintainability and cost.

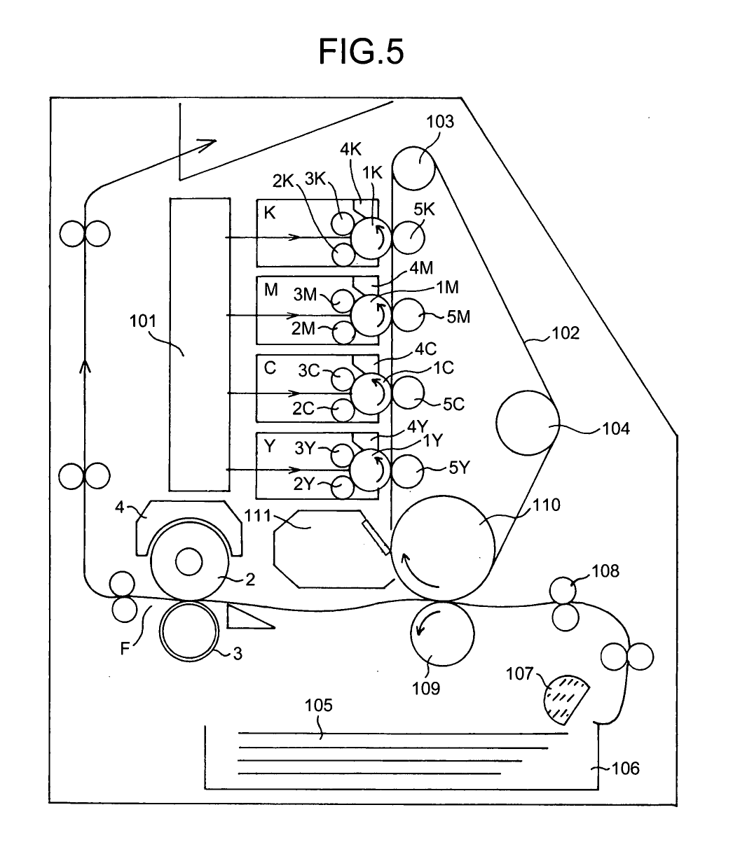

A full-color image forming apparatus that includes the fixing device according to the embodiment is explained with reference to FIG. 5.

The image forming apparatus is an electrophotographic full-color image forming apparatus that forms a full-color image by superposing toner images of four colors: yellow, cyan, magenta, and black.

In the color image forming apparatus, a so-called all-in-one cartridge is used in which photosensitive drums 1Y, 1C, 1M, and 1K as image carriers, charging rollers 2Y, 2C, 2M, and 2K as charging units, developing rollers 3Y, 3C, 3M, and 3K as developing units for visualizing an electrostatic latent image, cleaning units 4Y, 4C, 4M, and 4K for the photosensitive drums, and other components are collected in. one container.

In the embodiment, four cartridges are used: a yellow cartridge with a developer filled with yellow (Y) toner and carrier, a magenta cartridge with a developer filled with magenta (M) toner and carrier, a cyan cartridge with a developer filled with cyan (C) toner and carrier, a black cartridge with a developer filled with black (K) toner and carrier.

In the image forming apparatus, an optical system 101 that exposes the photosensitive drums 1Y, 1C, 1M, and 1K to light to form an electrostatic latent image is provided correspondingly to the four-color toner cartridges. As the optical system, a laser-scanning light-exposure optical system is used.

With the optical system 101, the photosensitive drums 1Y, 1C, 1M, and 1K uniformly charged by the charging rollers 2Y, 2C, 2M, and 2K as charging units are exposed to scanning light based on the image data, thereby forming an electrostatic latent image on the surfaces of the photosensitive drums 1Y, 1C, 1M, and 1K correspondingly to the image. Development is performed in a manner such that, by setting a developing bias applied to the developing rollers 3Y, 3C, 3M, and 3K from a bias power supply (not shown) at an appropriate value between a charging potential and a latent-image (exposed portion) potential, the toner charged at a negative polarity due to frictional electrification with the carrier is selectively attached to the electrostatic latent image on the photosensitive drums 1Y, 1C, 1M, and 1K.

To the single-color toner images developed on the photosensitive drums 1Y, 1C, 1M, and 1K, a primary transfer bias with a polarity opposite to the polarity of the toner is applied from the bias power supply to primary transfer rollers 5Y, 5C, 5M, and 5K. With this, primary transfer is made in which the toner image is transferred from each photosensitive drum onto an intermediate transfer member. In the embodiment, an intermediate transfer belt 102 is used as an intermediate transfer member, which is driven by a driving roller 103 and stretched by a tension roller 104.

After the primary transfer, residual transfer toner on the photosensitive drums 1Y, 1C, 1M, and 1K is removed by the cleaning units 4Y, 4C, 4M, and 4K. In the embodiment, a urethane blade is used for cleaning.

The process explained above is performed on each of the colors of yellow, magenta, cyan, and black in synchronization with the rotation of the intermediate transfer belt 102, thereby sequentially superposing and forming the primarily transferred toner images of the respective colors on the intermediate transfer belt 102. At the time of forming an image with only a single color (single-color mode), the process explained above is performed only on the target color.

A transfer material 105 as a material to be heated, which is set at a transfer-material cassette 106 serving as a transfer-material feeding unit is supplied by a supply roller 107 at a predetermined timing to a secondary transferring unit, and is conveyed by resist rollers 108 to a nip portion between the intermediate transfer belt 102 and the secondary transferring unit.

A bias applying unit (not shown) applies a bias voltage of a polarity opposite to that of the toner to a secondary transfer roller 109 as a secondary transfer unit. The secondary transfer roller 109 faces a roller 110. The primarily transferred toner images formed on the intermediate transfer belt 102 are collectively transferred onto the transfer material 105 due to the bias voltage.

Residual secondary transfer toner left on the intermediate transfer belt 102 after secondary transfer is removed by a cleaning device 111 as a cleaning unit for the intermediate transfer belt. In the embodiment, as with the cleaning unit for the photosensitive drum, the intermediate transfer member is cleaned with a urethane blade.

The toner image secondary-transferred onto the transfer material 105 passes through a fixing device F as a fixing unit, thereby being fused and fixed onto the transfer material 105 to form an output image from the image forming apparatus.

According to the embodiment of the present invention, a fixing device includes a fixing sleeve that can be freely rotated with respect to a fixing roller. With the fixing sleeve being slid for rotation, no bonding cost or yield due to bonding occurs. At the time of deterioration with time, the fixing sleeve and the fixing roller can be individually disassembled and replaced. Additionally, even when the fixing sleeve and the fixing roller can be freely rotated, the fixing sleeve is not shifted and no component runs upon another component.

Moreover, an image forming apparatus includes the fixing device with excellent maintainability. Therefore, maintenance at the time of the occurrence of a defect or deterioration of the device is easy. Furthermore, because the cost of the fixing device is low, the cost per sheet of an output image can be suppressed low.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A fixing device comprising:
a fixing sleeve that includes a heating layer that generates heat to fuse and fix toner;
a fixing roller that is cylindrical and has a surface covered with the fixing sleeve; and
a pressure roller that presses the fixing roller via the fixing sleeve to form a nip portion, wherein
the fixing sleeve is rotatable with respect to the fixing roller, and is slid for rotation.

2. The fixing device according to claim 1, wherein the fixing sleeve includes a protrusion that abuts the fixing roller and prevents the fixing sleeve from moving in an axial direction of the fixing sleeve, the protrusion being arranged on at least part of an axial-direction edge of an inner circumference surface of the fixing sleeve.

3. The fixing device according to claim 2, wherein the fixing roller has an outer diameter smaller than an inner diameter of the protrusion.

4. The fixing device according to claim 2, wherein the protrusion is arranged only on one side of the axial-direction edge.

5. The fixing device according to claim 2,.wherein the protrusion is bonded to the fixing sleeve after the fixing roller is covered with the fixing sleeve.

6. The fixing device according to claim 2, wherein
the fixing roller includes:
a core metal;
an elastic layer that surrounds an outer circumference surface of the core metal; and
a hard portion that has a hardness higher than a hardness of the elastic layer and is located on an axial-direction edge of an outer circumference surface of the elastic layer, and
the protrusion abuts the hard portion in the axial direction of the fixing sleeve.

7. The fixing device according to claim 6, wherein the hard portion is a ring member that fits on an end of the fixing roller.

8. The fixing device according to claim 7, wherein the ring member is non-magnetic.

9. The fixing device according to claim 7, wherein the pressure roller has an axial-direction length equal to or longer than an axial-direction length of the fixing roller including the ring member.

10. The fixing device according to claim 6, wherein the hard portion is rigid.

11. The fixing device according to claim 6, wherein the hard portion is elastic.

12. The fixing device according to claim 1, wherein the heating layer includes an electromagnetic induction mechanism that generates heat through electromagnetic induction.

13. The fixing device according to claim 1, wherein an entire inner circumference surface of the fixing sleeve is in contact with the fixing roller.

14. The fixing device according to claim 1, wherein grease is applied to an inner surface of the fixing sleeve.

15. The fixing device according to claim 14, wherein the grease is fluorine grease.

16. The fixing device according to claim 1, further comprising a mechanism that adjusts parallelism between the fixing roller and the pressure roller.

17. An image forming apparatus comprising:
a fixing device that includes
a fixing sleeve that includes a heating layer that generates heat to fuse and fix toner;
a fixing roller that is cylindrical and has a surface covered with the fixing sleeve; and
a pressure roller that presses the fixing roller via the fixing sleeve to form a nip portion, wherein
the fixing sleeve is rotatable with respect to the fixing roller, and is slid for rotation.
